(19) United States
(12) Patent Application Publication
(10) Pub. No.: US 2023/0373195 A1
(43) Pub. Date: Nov. 23, 2023

(54) LAMINATED GLAZING

(71) Applicant: Pilkington Group Limited, Lathom (GB)

(72) Inventors: Srikanth VARANASI, Ottawa Hills, OH (US); Timothy MCKITTRICK, Perrysburg, OH (US)

(21) Appl. No.: 18/246,867

(22) PCT Filed: Sep. 27, 2021
(86) PCT No.: PCT/GB2021/052507

§ 371 Date: Mar. 28, 2023

Related U.S. Application Data
(60) Provisional application No. 63/084,163, filed on Sep. 28, 2020.

(51) Int. Cl. B32B 17/10; C03C 17/06; C03C 17/245

(52) U.S. Cl. CPC B32B 17/10449; B32B 17/10036; B32B 17/10119; B32B 17/10761; B32B 17/10779; B32B 17/1022; B32B 17/10183; B32B 17/10807; C03C 17/06; C03C 17/245; B32B 2307/7376; B32B 2605/08; G01S 17/931

(57) ABSTRACT

A laminated glazing and a method for its production is disclosed. One or more coatings and layers are applied onto or disposed between a pair of sheets to produce such laminated glazing that enhances an accuracy and reliability of an optical sensor coupled thereto. More particularly, the laminated glazing includes an antireflective layer to facilitate a light transmission of at least 80% for a plurality of wavelengths through the laminated glazing.

The subject matter of the embodiments described herein relates generally to a laminated glazing and, more particularly, to a laminated glazing that is suitable for an optical sensor in a vehicle.

Autonomous vehicles are being developed to be the vehicles of the future. These vehicles are designed to increase safety, road capacity, and fuel efficiency while reducing pollution, driver stress, and operating costs. It is estimated that by the year 2040, autonomous vehicles could represent forty percent (40%) of all vehicles on the road.

Typically, the autonomous vehicles detect surroundings using various sensors including, but not limited to optical sensors such as radar, LIDAR (Light Detection And Ranging), GPS, Odometry, and computer vision, for example. Particularly, a LIDAR sensor is an optical sensor that uses light to detect a condition which it then quantitatively describes. The “light” being electromagnetic radiation extending from a visible region and into an infrared region of a visible spectrum (having a wavelength in a range of approximately 400 nm to 2500 nm).

The autonomous vehicles may include at least one LIDAR sensor positioned at various locations on the vehicle body. For example, the LIDAR sensors may be disposed on an exterior of the autonomous vehicle such as a roof, external mirrors, bumpers, headlights and taillights, and vehicle side panels, for example. However, the exterior LIDAR sensors are unaesthetic, interfere with the sleek lines of the vehicle design, and have an increased exposure and risk of damage by external environmental conditions.

To overcome the drawbacks of the exterior LIDAR sensors, it is well known to integrate the LIDAR sensors into a vehicle windshield or position the LIDAR behind the vehicle windshield. Typically, the LIDAR sensor is mounted on an interior surface of the vehicle windshield to provide a suitable position for geometrical distance estimation, an enhanced view of a road surface and traffic situation, and a controlled environment to operate the LIDAR sensor. Thus, the LIDAR sensor facilitates precise mapping of a vehicle surrounding which is used to safely operate the autonomous vehicle. With improved technology, the LIDAR sensors require an increased light transmission and are therefore not fully compatible with conventional windshield configurations.

Currently, the prior art laminated glazings employed as vehicle windshields do not allow a sufficient amount of light with enough intensity to be transmitted through the windshield for proper operation and performance of the LIDAR sensor. Typically, the windshields, positioned at an angle of about 60° from vertical, have a light transmission of about 22% (when measured with CIE Illuminant A) for an infrared light wavelength of about 905 nm and about 36% (when measured with CIE Illuminant A) for an infrared light wavelength of about 1550 nm.

Accordingly, it would be desirable to produce a laminated glazing for vehicle windshields that is designed for use with an optical sensor, which provides sufficient light transmission for the optical sensor to operate properly and efficiently while enhancing performance thereof.

In concordance and agreement with the present disclosure, a laminated glazing for use with an optical sensor that provides sufficient infrared transmission for the optical sensor to operate properly and efficiently while enhancing performance thereof, has surprisingly been discovered.

In one embodiment, a laminated glazing, comprises: a first sheet; a second sheet; an adhesive layer interposed between the first sheet and the second sheet to join the first sheet to the second sheet; and an antireflective layer disposed adjacent one of the first sheet and the second sheet, wherein the antireflective layer facilitates a light transmission of at least 80% for at least one wavelength through the laminated glazing.

As aspects of certain embodiments, at least one of the first sheet and the second sheet are produced from a generally low-light absorption, high-light transmission glass material.

As aspects of certain embodiments, the glass material has an iron content less than 100 ppm.

As aspects of certain embodiments, the adhesive layer comprises a single ply.

As aspects of certain embodiments, the adhesive layer includes at least one ply of polyvinyl butyral (PVB), ethylene vinyl acetate (EVA), polyvinyl chloride (PVC), polyurethane (PU), acoustic modified PVB and Uvekol® (a liquid curable acrylic resin).

As aspects of certain embodiments, the adhesive layer comprises a plurality of plies.

As aspects of certain embodiments, the adhesive layer includes a first ply formed of PVB, a second ply formed of polyethylene terephthalate (PET), and a third ply formed of PVB.

As aspects of certain embodiments, the laminated glazing further comprises at least one reflecting layer.

As aspects of certain embodiments, the at least one reflecting layer is disposed adjacent one of the first sheet and the second sheet.

As aspects of certain embodiments, the at least one reflecting layer comprises a metal material.

As aspects of certain embodiments, the at least one reflecting layer includes a void formed therein.

As aspects of certain embodiments, the antireflective layer is formed to cover at least a portion of at least one of the first sheet and the second sheet.

As aspects of certain embodiments, each of the first sheet and the second sheet includes a first major surface and a second major surface, wherein the antireflective layer is disposed adjacent the second major surface of the second sheet.

As aspects of certain embodiments, the antireflective layer has a thickness of at least 80 nm.

As aspects of certain embodiments, the antireflective layer has a thickness in a range of about 120 nm to about 200 nm.

As aspects of certain embodiments, the antireflective layer is formed of silica.

As aspects of certain embodiments, the antireflective layer facilitates a light transmission of at least 94% for the at least one wavelength through the laminated glazing.

As aspects of certain embodiments, the at least one wavelength is in a range of about 750 nm to about 1 mm.

As aspects of certain embodiments, the antireflective layer facilitates a desired light transmission for at least one of a first wavelength and a second wavelength.

As aspects of certain embodiments, the first wavelength is about 905 nm.

As aspects of certain embodiments, the second wavelength is about 1550 nm.

As aspects of certain embodiments, a light beam having the at least one wavelength is emitted from at least one optical sensor positioned proximate the laminated glazing.

In another embodiment, a laminated glazing comprises: a first sheet formed of a glass material having a content of iron oxide (Fe₂O₃) of about 100 ppm or less; a second sheet formed of a glass material having a content of iron oxide (Fe₂O₃) of about 100 ppm or less; an adhesive layer interposed between the first sheet and the second sheet to join the first sheet to the second sheet; and an antireflective layer disposed adjacent one of the first sheet and the second sheet, wherein the antireflective layer facilitates a light transmission of at least 80% for at least one infrared wavelength through the laminated glazing.

In another embodiment, a laminated glazing for a vehicle, comprises: a first sheet formed of a glass material having a content of iron oxide (Fe₂O₃) of about 100 ppm or less; a second sheet formed of a glass material having a content of iron oxide (Fe₂O₃) of about 100 ppm or less; an adhesive layer interposed between the first sheet and the second sheet to join the first sheet to the second sheet; at least one reflecting layer disposed adjacent at least one of the first sheet and the second sheet, wherein the at least one reflecting layer includes a void formed therein, and wherein the void is formed in alignment with an optical sensor to facilitate a transmission of at least one light beam emitted from the optical sensor having a predetermined wavelength through the void; and an antireflective layer disposed adjacent at least a portion of at least one of the first sheet and the second sheet, wherein the portion of the at least one of the first sheet and the second sheet is in alignment with the optical sensor to facilitate the transmission of the at least one light beam emitted from the optical sensor having the predetermined wavelength through the antireflective layer.

In yet another embodiment, a method of producing a laminated glazing, comprises: providing a first sheet; providing a second sheet; disposing an adhesive layer between the first sheet and the second sheet to join the first sheet to the second sheet; and disposing an antireflective layer adjacent one of the first sheet and the second sheet, wherein the antireflective layer facilitates a light transmission of at least 80% for a plurality of wavelengths through the laminated glazing.

As aspects of certain embodiments, the method further comprises the step of disposing at least one reflecting layer adjacent one of the first sheet and the second sheet.

Aspects and embodiments in the method will be apparent from those described for the laminated glazing.

The above, as well as other objects and advantages of the subject matter of the embodiments described herein, will become readily apparent to those skilled in the art from a reading of the following detailed description of the embodiments when considered in the light of the accompanying drawings in which:

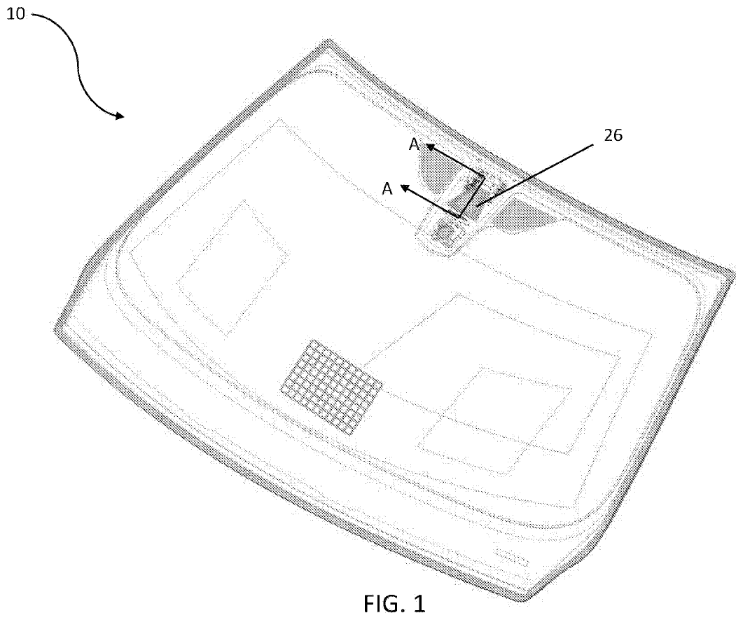

FIG. 1 is a schematic isometric view of a laminated glazing according to an embodiment of the presently disclosed subject matter, wherein the laminated glazing is employed as a windshield for a vehicle;

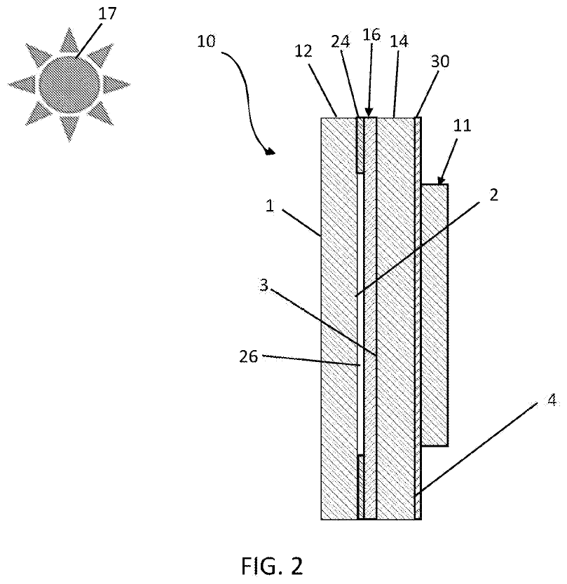

FIG. 2 is a cross-sectional view taken along the line A-A of the laminated glazing according to an embodiment of the presently disclosed subject matter; and

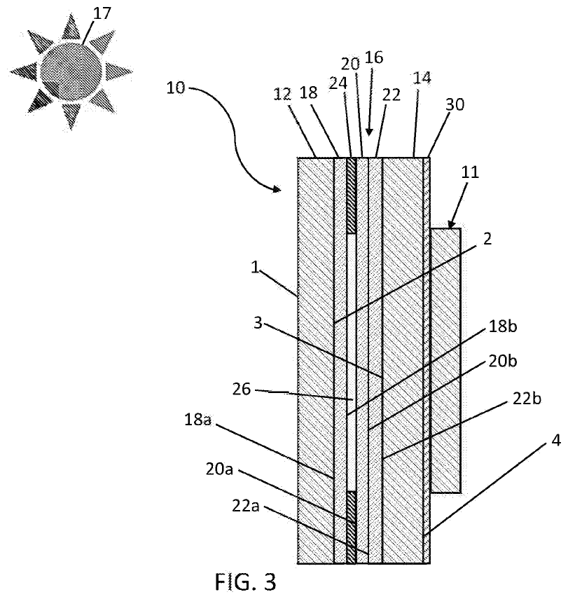

FIG. 3 is a cross-sectional view taken along the line A-A of the laminated glazing according to another embodiment of the presently disclosed subject matter; and

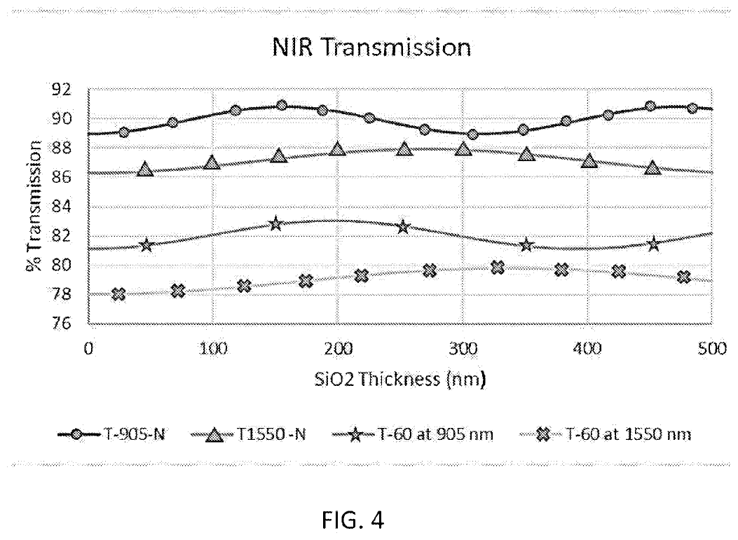

FIG. 4 is a plot of percentage transmission (y-axis) against a thickness of an anti-reflective layer (x-axis) for the embodiment shown in FIG. 3.

The following detailed description and appended drawings describe and illustrate various exemplary embodiments. The description and drawings serve to enable one skilled in the art to make and use the embodiments, and are not intended to limit the scope of the embodiments in any manner.

FIG. 1 depicts a multi-layer laminated glazing 10 according to an embodiment of the presently described subject matter. According to the presently disclosed subject matter, the laminated glazing 10 may be planar. However, the laminated glazing 10 may also be curved such as employed in the case in the automotive industry for rear windows, side windows, sun and moon roofs, and especially windshields. Preferably, a radius of curvature in at least one direction is in a range of about 500 mm to about 20,000 mm, and more preferably, in a range of about 1000 mm to about 8,000 mm.

The laminated glazing 10 is configured to be used with an optical sensor 11 in a vehicle (not depicted). It should be appreciated, however, that the laminated glazing 10 may be used in various other applications, as desired. The laminated glazing 10 of the presently disclosed subject matter is positioned at a rake angle in a range of about 50° to 70° from vertical and has a light transmission (when measured with CIE Illuminant A) of at least 75% for two or more wavelengths in a range of about 750 nm to 1 mm. Preferably, the laminated glazing 10 is positioned at a rake angle of about 60° from vertical and has a light transmission (when measured with CIE Illuminant A) of at least 94% at a first wavelength of about 905 nm and a second wavelength of about 1550 nm.

As shown in FIGS. 2 and 3, the laminated glazing 10 consists of a first sheet 12 and a second sheet 14 joined to the first sheet 12 by an adhesive interlayer 16. The first and second sheets 12, 14 may be substantially clear and transparent to visible light. Each of the first and second sheets 12, 14 may be produced from a generally low-absorption, high-transmission glass material. In certain embodiments, the first and second sheets 12, 14 may be produced from any glass composition and produced through the use of any glass manufacturing process. Preferably, each of the first and second sheets 12, 14 is produced from a soda-lime-silica material. A typical soda-lime-silica material composition is (by weight), silicon dioxide (SiO₂) 70-75%; aluminum oxide (Al₂O₃) 0-5%; sodium oxide (Na₂O) 10-15%; potassium oxide (K₂O) 0-5%; Magnesium oxide (MgO) 0-10%; calcium oxide (CaO) 5-15%; sulfur trioxide (SO₃) 0-2%. It is understood, however, the first and second sheets 12, 14 each may comprise another composition such as a borosilicate composition, for example.

In certain embodiments, each of the first and second sheets 12, 14 is produced from a generally low-iron glass material. Preferably, the first and second sheets 12, 14 are produced from a glass material having a content of iron oxide (Fe₂O₃) of about 100 ppm or less. More preferably, the content of iron oxide (Fe₂O₃) in the first and second sheets 12, 14 is about 10 ppm or less. Also, the transparency or absorption characteristics of the first and second sheets 12, 14 may vary between embodiments of the laminated glazing 10. For example, the first and second sheets 12, 14 may be tinted. Additionally, a thickness of each of the first and second sheets 12, 14 may vary between embodiments of the laminated glazing 10. In certain embodiments, a thickness of each of the first and second sheets 12, 14 is in a range of about 0.7 mm to about 12 mm. Preferably, each of the first and second sheets 12, 14 has a thickness of about 2.2 mm.

The first sheet 12 has a first major surface 1 and an opposing second major surface 2. The second sheet 14 has a first major surface 3 and an opposing second major surface 4. When the laminated glazing 10 is employed as a windshield in a vehicle, the major surface 1 faces towards an exterior environment (as indicated by a sun 17) and the second major surface 4 faces an interior of the vehicle. As such, the first sheet 12 is the “outer pane” of the windshield and the second sheet 14 is the “inner pane” of the windshield.

As illustrated in FIGS. 1 and 2, the adhesive interlayer 16 is interposed between the first and second sheets 12, 14. Similar to the first and second sheets 12, 14, a transparency or absorption characteristics of the interlayer 16 may vary between the embodiments of the laminated glazing 10. For example, the adhesive interlayer 16 may be tinted, if desired. In one embodiment shown in FIG. 2, the adhesive interlayer 16 comprises a single ply disposed adjacent the second major surface 2 of the first sheet 12 and the first major surface 3 of the second sheet 14. The single-ply adhesive interlayer 16 may be formed from a polyvinyl butyral (PVB), ethylene vinyl acetate (EVA), polyvinyl chloride (PVC), polyurethane (PU), acoustic modified PVB or Uvekol® (a liquid curable acrylic resin). A thickness of the single-ply adhesive interlayer 16 is in a range of about 0.3 mm to about 2.3 mm. Preferably, the single-ply adhesive interlayer 16 has a thickness in a range of about 0.3 mm to about 1.1 mm, and more preferably about 0.76 mm. More preferably, the laminated glazing 10 employs Pilkington Optiwhite™, commercially available by Pilkington Group Limited, for the glass sheets 12, 14 joined by the single-ply adhesive layer 16. Most preferably, the glass sheets 12, 14 of the Pilkington Optiwhite™, each has a thickness of about 2.2 mm, and the single-ply interlayer 16 of the Pilkington Optiwhite™ has a thickness of about 0.76 mm.

In another embodiment shown in FIG. 3, the adhesive interlayer 16 is a multi-ply interlayer comprising a first ply 18 formed of PVB, a second ply 20 formed of polyethylene terephthalate (PET), and a third ply 22 formed of PVB. It is understood that each of the plies 18, 20, 22 may be formed from other suitable adhesive materials as desired. Each of the plies 18, 20, 22 includes respective first surfaces 18a, 20a, 22a and opposing second surfaces 18b, 20b, 22b. As illustrated, the first ply 18 is disposed adjacent the second major surface 2 of the first sheet 12 and the first surface 20a of the second ply 20. The second ply 20 is disposed adjacent the second surface 18b of the first ply 18 and the first surface 22a of the third ply 22. The third ply 22 is disposed adjacent the second surface 20b of the second ply 20 and the first major surface 3 of the second sheet 14. A thickness of the first ply 18 is in a range of about 0.3 mm to about 2.3 mm, and more preferably about 0.38 mm. The intermediate second ply 20 has a thickness in a range of about 0.01 mm to 1.0 mm, and more preferably about 0.05 mm. A thickness of the third ply 22 is in a range of about 0.3 mm to about 2.3 mm, and more preferably about 0.76 mm. Various other adhesive materials may be used to produce the interlayer 16 as desired. It should be appreciated that the thickness of the adhesive interlayer 16 may vary between embodiments of the laminated glazing 10 according to the presently disclosed subject matter.

In certain embodiments, the laminated glazing 10 may further include at least one reflecting layer 24. As shown in FIG. 2, the at least one reflecting layer 24 may be disposed adjacent the adhesive interlayer 16 on either the second major surface 2 of the first sheet 12 or the first major surface 3 of the second sheet 14. In certain embodiments, the laminated glazing 10 includes two reflecting layers 24 disposed adjacent at least one of the first and second sheets 12, 14. Alternatively, as illustrated in FIG. 3, the at least one reflecting layer 24 may be incorporated into the multi-ply interlayer 16. In one embodiment, the at least one reflecting layer 24 is disposed on the second surface 18b of the first ply 18 adjacent the first surface 20a of the second ply 20. In another embodiment, the at least one reflecting layer 24 may be disposed on the second surface 20b of the second ply 20 adjacent the first surface 22a of the third ply 22. In certain embodiments, the laminated glazing 10 includes three reflecting layers 24 incorporated into the multi-ply interlayer 16.

The at least one reflecting layer 24 shown reflects solar and/or infrared radiation and may be formed of a metal material (e.g. silver), tin-doped indium oxide, lanthanum hexaboride or other such suitable infrared reflecting material. In certain embodiments, the at least one reflecting layer 24 is deposited by sputtering. Various other methods may be used to form the at least one reflecting layer 24 if desired. Although the at least one reflecting layer 24 may extend over substantially an entire surface of the sheets 12, 14 or the plies 18, 20, 22, it may be formed to extend over only a portion of the surface thereof. The peripheral edges of the at least one reflecting layer 24 and the second ply 20 may be offset from peripheral edges of the adjacent plies 18, 22 to militate against corrosion and damage. A thickness of the at least one reflecting layer 24 is in a range of about 10 nm to about 20 nm. It is understood that the at least one reflecting layer 24 may have any suitable thickness as desired.

Advantageously, the at least one reflecting layer 24 may include a void 26, shown in FIGS. 1-3, formed in at least one desired location to militate against potential interference of the at least one reflecting layer 24 with surrounding components (e.g. the optical sensor 11, camera, cellular telephone, global positioning systems, road and parking transponders, various other sensors, and the like, etc.). The void 26 in the at least one reflecting layer 24 may be formed during a manufacturing of the laminated glazing 10 (e.g. masking the laminated glazing 10 at the desired location) or removing a portion of the at least one reflecting layer 24 by any suitable method such as laser or mechanical deletion or etching, for example. The void 26 in the at least one reflecting layer 24 may cover a continuous area or be in the form of a desired configuration such as a lined or grid pattern, for example.

As shown, the laminated glazing 10 may further include an antireflective (AR) layer 30.

Preferably, the laminated glazing 10 is configured such that the light transmission (when measured with CIE Illuminant A) in a region of the laminated glazing 10 visible by an occupant of the vehicle is substantially equivalent to the laminated glazing 10 without the AR layer 30, while the light transmission (when measured with CIE Illuminant A) of at least one of the first and second wavelengths in a region of the laminated glazing 10 aligned with the optical sensor 11 is greater than the laminated glazing 10 without the AR layer 30. Preferably, the light transmission (when measured with CIE Illuminant A) of at least one of the first and second wavelengths in the region of the laminated glazing 10 aligned with the optical sensor 11 is maximized.

Preferably, the AR layer 30 is formed over the second major surface 4 of the second sheet 14. More preferably, the AR layer 30 is formed directly on second major surface 4 on the second sheet 14, essentially with no intervening layers. It is understood, however, that the AR layer 30 may be formed on other surfaces of the laminated glazing 10 such as the first major surface 1 of the first sheet 12, for example. As non-limiting examples, the AR layer 30 may be an additional coating deposited on the second sheet 14 or an antireflective film disposed thereon. Although the AR layer 30 may extend over substantially an entire surface of the sheets 12, 14 or the plies 18, 20, 22, it may be formed to extend over only a portion of the surface thereof.

In one embodiment, the AR layer 30 is a single layer coating which comprises silicon dioxide (SiO₂) deposited by chemical vapor deposition (CVD). In another embodiment, the AR layer 30 is a single layer coating which comprises titanium oxide (TiO₂) nanoparticles deposited by a sol-gel process. It should be appreciated that the AR layer 30 may not comprise a material having solar absorption properties such as a tin oxide (SnO₂), for example. It is understood that the AR layer 30 may be a multi-layer coating formed of any suitable material, as desired.

The AR layer 30 may be selectively formed at a desired thickness to achieve a desired transmission percentage therethrough. In certain embodiments, the thickness of the AR layer 30 is such that to achieve optimal transmission of at least one of the first wavelength and the second wavelength through the laminated glazing 10. Preferably, the thickness of the AR layer 30 may such that to achieve at least an 80% transmission through the laminated glazing 10 of at least one of the first and second wavelengths. More preferably, the thickness of the AR layer 30 is such that to achieve at least a 90% transmission through the laminated glazing 10 of at least one of the first and second wavelengths. Most preferably, the thickness of the AR layer 30 is such that to achieve at least a 94% transmission through the laminated glazing 10 of at least one of the first and second wavelengths.

In certain embodiments, the AR layer 30 is deposited at a thickness of no less than about 80 nm, and more preferably no less than about 100 nm. In other embodiments, the thickness of the AR layer 30 is in a range of about 80 nm to about 400 nm, preferably in a range of about 100 nm to about 350 nm, and more preferably in a range of about 120 nm to about 200 nm. As illustrated in FIG. 4 (see line with star), the laminated glazing 10 positioned at a rake angle of about 60° exhibits about a 81.7% transmission at the first wavelength (e.g. 905 nm) when the thickness of the AR layer 30 is about 80 nm, about an 82.4% transmission at the first wavelength when the thickness of the AR layer 30 is about 120 nm, and about an 83% transmission at the first wavelength when the thickness of the AR layer 30 is about 200 nm. Similarly, the laminated glazing 10 positioned at a rake angle of about 60° exhibits about a 78.2% transmission at the second wavelength (e.g. 1550 nm) when the thickness of the AR layer 30 is about 80 nm, about an 78.5% transmission at the second wavelength when the thickness of the AR layer 30 is about 120 nm, about an 79.2% transmission at the second wavelength when the thickness of the AR layer 30 is about 200 nm, and about an 79.7% transmission at the second wavelength when the thickness of the AR layer 30 is about 350 nm (see line with cross). It is understood that each layer of each embodiment of the AR layer 30 may have any desired thickness. It is further understood that the AR layer 30 may comprise as many or as few of layers as desired. Various other materials and methods may be employed to produce the laminated glazing 10 with antireflective properties.

Referring now to FIGS. 2 and 3, the optical sensor 11 may be a light detection and ranging (LIDAR) type of sensor. Such LIDAR sensors include but are not limited to pedestrian detection sensors, pre-crash sensors, closing velocity sensors, and adaptive cruise control sensors, for example. In certain embodiments, the optical sensor 11 may be an optoelectronic system composed of at least a laser or sensing beam transmitter, at least a receiver comprising a light or sensing beam collector (telescope or other optics) and at least a photodetector which converts the light or sensing beam into an electrical signal and an electronic processing chain signal that extracts the information sought.

In use, the optical sensor 11 emits the sensing beam through the laminated glazing 10, which strikes a remote object. The sensing beam is reflected off of the object and caused to pass back through the laminated glazing 10 and detected by the receiver of the optical sensor 11. Most often, the initial sensing beam emitted from the optical sensor 11 and the reflected sensing beam received by the optical sensor 11 each have the same wavelength, preferably one of the first and second wavelengths. Thereafter, the photodetector converts the sensing beam into the electrical signal which is then transmitted to a controller or microcontroller 13.

As illustrated, the optical sensor 11 may be disposed on the second major surface 4 of the second sheet 12. It is understood, however, that the optical sensor 11 may be positioned at other suitable locations on or adjacent to the laminated glazing 10. In certain embodiments, the optical sensor 11 may be positioned in alignment with the void 26 formed in the at least one reflecting layer 24 and at least a portion of the AR layer 30 to minimize interference and maximize the transmission % of at least one of the wavelengths through the laminated glazing 10, which results in improved accuracy and reliability of the optical sensor 11.

Referring now to FIG. 2, the laminated glazing 10 is shown according to one embodiment of the presently disclosed subject matter. The laminated glazing 10 includes the first sheet 12 having the at least one reflecting layer 24 disposed adjacent the second major surface 2 thereof. The single-ply adhesive layer 16 is disposed adjacent the at least one reflecting layer 24. More particularly, the at least one reflecting layer 24 of silver is deposited onto the adhesive layer 16 by sputtering. The void 26 is formed in the at least one reflecting layer 24 at the desired location of the void 26 during the manufacturing of the laminated glazing 10. The second sheet 14 is disposed adjacent the at least one reflecting layer 24. The AR layer 30 is then deposited onto the second major surface 4 of the second sheet 14. The optical sensor 11 is disposed adjacent the AR layer 30 in alignment with the void 26 formed in the at least one reflecting layer 24.

FIG. 3 shows the laminated glazing 10 according to another embodiment of the presently disclosed subject matter. The laminated glazing 10 includes the first sheet 12 having the first ply 18 of the multi-ply adhesive layer 16 disposed adjacent the second major surface 2 thereof. The at least one reflecting layer 24 is disposed adjacent the second surface 18b of the first ply 18. The second ply 20 is disposed adjacent the at least one reflecting layer 24. More particularly, the at least one reflecting layer 24 of silver is deposited on the first surface 20a of the second ply 20 by sputtering. The void 26 is formed in the at least one reflecting layer 24 at the desired location of the void 26 during the manufacturing of the laminated glazing 10. The third ply 22 is then disposed adjacent the second surface 20b of the second ply 20. The second sheet 14 is disposed adjacent the second surface 22b of the third ply 22. The AR layer 30 is then deposited onto the second major surface 4 of the second sheet 14. The optical sensor 11 is disposed adjacent the AR layer 30 in alignment with the void 26 formed in the at least one reflecting layer 24.

From the foregoing description, one ordinarily skilled in the art can easily ascertain the essential characteristics of the subject matter of the embodiments described herein and, without departing from the spirit and scope thereof, can make various changes and modifications to the embodiments to adapt them to various usages and conditions.

What is claimed is:

1.-25. (canceled)

26. A laminated glazing, comprising:
a first sheet;
a second sheet;
an adhesive layer interposed between the first and second sheets to join the first sheet to the second sheet; and
an antireflective layer disposed adjacent one of the first sheet and the second sheet, wherein the antireflective layer facilitates a light transmission of at least 80% for at least one wavelength through the laminated glazing.

27. The laminated glazing of claim 26, wherein the first sheet and the second sheet are formed from a glass material having a content of iron oxide (Fe₂O₃) of about 100 ppm or less.

28. The laminated glazing of claim 26, wherein the adhesive layer comprises a single ply or a plurality of plies.

29. The laminated glazing of claim 26, wherein the adhesive layer includes at least one ply of polyvinyl butyral (PVB), ethylene vinyl acetate (EVA), polyvinyl chloride (PVC), polyurethane (PU), acoustic modified PVB and a liquid curable acrylic resin.

30. The laminated glazing of claim 26, wherein the adhesive layer includes a first ply formed of polyvinyl butyral (PVB), a second ply formed of polyethylene terephthalate (PET), and a third ply formed of PVB.

31. The laminated glazing of claim 26, further comprising at least one reflecting layer.

32. The laminated glazing of claim 31, wherein the at least one reflecting layer is disposed adjacent one of the first sheet and the second sheet.

33. The laminated glazing of claim 31, wherein the at least one reflecting layer comprises a metal material.

34. The laminated glazing of claim 31, wherein the at least one reflecting layer includes a void formed therein.

35. The laminated glazing of claim 26, wherein the antireflective layer is formed to cover at least a portion of at least one of the first sheet and the second sheet.

36. The laminated glazing of claim 26, wherein each of the first sheet and the second sheet includes a first major surface and a second major surface, and wherein the antireflective layer is disposed adjacent the second major surface of the second sheet.

37. The laminated glazing of claim 26, wherein the antireflective layer has a thickness of at least 80 nm.

38. The laminated glazing of claim 26, wherein the antireflective layer has a thickness in a range of about 120 nm to about 200 nm.

39. The laminated glazing of claim 26, wherein the antireflective layer is formed of silicon dioxide (SiO₂).

40. The laminated glazing of claim 26, wherein the antireflective layer facilitates a light transmission of at least 94% for the at least one wavelength through the laminated glazing.

41. The laminated glazing of claim 26, wherein the at least one wavelength is in a range of about 750 nm to about 1 mm.

42. The laminated glazing of claim 26, wherein the antireflective layer facilitates a desired light transmission for at least one of a first wavelength and a second wavelength, wherein the first wavelength is about 905 nm and the second wavelength is about 1550 nm.

43. A laminated glazing for a vehicle, comprising:
a first sheet formed of a glass material having a content of iron oxide (Fe₂O₃) of about 100 ppm or less;
a second sheet formed of a glass material having a content of iron oxide (Fe₂O₃) of about 100 ppm or less;
an adhesive layer interposed between the first sheet and the second sheet to join the first sheet to the second sheet;
at least one reflecting layer disposed adjacent at least one of the first sheet and the second sheet, wherein the at least one reflecting layer includes a void formed therein, and wherein the void is formed in alignment with an optical sensor to facilitate a transmission of at least one light beam emitted from the optical sensor having a predetermined wavelength through the void; and
an antireflective layer disposed adjacent at least a portion of at least one of the first sheet and the second sheet, wherein the portion of the at least one of the first sheet and the second sheet is in alignment with the optical sensor to facilitate the transmission of the at least one light beam emitted from the optical sensor having the predetermined wavelength through the antireflective layer.

44. A method of producing a laminated glazing, comprising:
providing a first sheet;
providing a second sheet;
disposing an adhesive layer between the first sheet and the second sheet to join the first sheet to the second sheet; and
disposing an antireflective layer adjacent one of the first sheet and the second sheet, wherein the antireflective layer facilitates a light transmission of at least 80% for at least one of wavelength through the laminated glazing.

45. The method of claim 44, further comprising the step of disposing at least one reflecting layer adjacent one of the first sheet and the second sheet.
